(19) United States
(12) Patent Application Publication
(10) Pub. No.: US 2009/0207986 A1
(43) Pub. Date: Aug. 20, 2009

(54) Telecommunications system

(76) Inventors: Florian Buzin, Karlsruhe (DE); Barbara Mauve, Karlsruhe (DE)

Correspondence Address: COLLARD & ROE, P.C., 1077 NORTHERN BOULEVARD, ROSLYN, NY, 11576, US

(21) Appl. No.: 12/378,200

(22) Filed: Feb. 12, 2009

(30) Foreign Application Priority Data
Feb. 15, 2008 (DE) 10 2008 009 416.1

(51) Int. Cl. H04M 11/00

(52) U.S. Cl. 379/102.01

(57) ABSTRACT

A telecommunications system simplifies programming of telephone systems and expands such programming to include possibilities in addition to the required functionality for producing communications between subscribers. A user interface is provided for simple programming of functions and modules according to the modular principle. The most varied terminals can be controlled by way of the telephone as a control device using this interface.

### CROSS REFERENCE TO RELATED APPLICATIONS

Applicants claim priority under 35 U.S.C. 119 of German Application No. 10 2008 009 416.1 filed Feb. 15, 2008.

### BACKGROUND OF THE INVENTION

1. Field of the Invention

The present invention relates to a telecommunications system having open interfaces, for producing a data connection with terminals, and an administration device for administering these terminals. The administration device can be programmed by way of a user interface, which allows the creation of functions and/or modules for controlling the terminals composed of ready-made functional modules.

2. The Prior Art

Fundamentally, a traditional telecommunications system consists of three essential components, namely a switch, a dial plan, and a routing database. In this connection, the switch carries out communication of such a telephone system with external telephony devices.

The dial plan contains the central logic that is needed to connect telephone calls with the dialed target, in each instance. It controls the switch to process the call initiation and the call termination. The routing database is a data memory that contains data about the allocation of telephone numbers and subscribers. It is used by the dial plan in order to determine where telephone calls have to be switched through to.

It is known to individually program such telephone systems by a user. For example, it is usual to assign a telephone number to a phone, which this phone can then also take along to a different line.

In this connection, however, it is generally possible to use and configure only predetermined functions for specific terminals. Changing functions or creating new functions requires technical knowledge that usually goes beyond the average capabilities of a user.

### SUMMARY OF THE INVENTION

In view of this background, it is an object of the invention to provide a telecommunications system that allows the possibility of far-reaching individualization of the functions, whereby the creation of the functions is simplified and made easy to understand for an average user.

These and other objects are achieved according to the invention by a telecommunications system having open interfaces for producing a data connection with terminals and an administration device for administering these terminals, whereby the administration device can be programmed by way of a user interface, which allows the creation of functions and/or modules for controlling the terminals composed of ready-made functional modules. Other practical embodiments of the telecommunications system according to the invention can be derived from the discussion below.

According to the invention, the telecommunications system is connected with its terminals by way of open interfaces. In this connection, terminals can be both telephones and any other form of electronic devices. It is merely necessary that the electrical device used as a terminal needs an electrical setting signal. This setting signal can then be triggered by way of a setting device provided for this purpose, which receives a corresponding control signal from the telecommunications system. In order to produce a plurality of different setting commands, and also to implement program sequences, programming of functions and modules is provided. These functions and modules can be composed of individual, predetermined or also freely programmable functional components, so that processing of a module to be created merely has to take place on the configuration plane, but not on the programming plane. In this connection, configuration takes place by way of a user interface. The user interface is preferably configured as a graphic interface and simplifies and supports creation of the modules for the user.

On the other hand, it is also supplementally possible to freely write modules directly, and to do without the user interface, which functions according to the modular principle. In this manner, the telecommunications system is equally attractive to more users and less skilled users.

After a module has been implemented, it must also be instantiated, in other words assigned to a command chain in the form of a program also for the instance performing the function, in other words a terminal. As soon as this assignment has been done, the terminal can be addressed with a command. In this connection, using a telecommunications system has several advantages. First of all, a telecommunication system is present and distributed practically in the entire house. Second of all, the telephone is available as an ideal input device for controlling the programmed functions. Therefore, to control a terminal, a telephone number is assigned to it during instantiation, so that a setting signal is generated when the telephone number is dialed by a user—authorization of the user can be required—and the terminal reacts to this setting signal. For example, in the case of stairwell lighting, a turn-on process can be triggered if the building supervisor calls a corresponding number, and a turn-off process when he or she calls the number again. It is therefore not necessary for the user to provide a special control device. Furthermore, the telephone as a control device is comprehensible and familiar to everyone.

The telecommunications system can be present in hardware terms, on the one hand, but alternatively, there is also the possibility that it is implemented purely virtually, on a computer, for example on a server that is present in any case. This implementation is particularly practical because it is advantageous to carry out creation of the modules and functions on the computer, as well. It is not necessary, because graphic configuration can take place on a handheld PC or another graphic input device, but it is useful in practical situations.

In particular, programming can be carried out graphically, in that a flow diagram is drawn up, which represents the processes within the module, component by component. For example, steps that take place one after the other are arranged below one another; alternative steps can then be implemented and visualized either by indentations or by arranging them at the same level.

In view of the open interfaces to be used, it is sometimes also practical if the created functions are first created in platform-independent manner, in a language such as the extensible markup language XML, and are translated for implementation, for example in Java or binary code. This feature requires independence of the individual function and the individual module, respectively, from the instance to be controlled in a concrete case.

The telecommunications system has a module framework as the central administration unit for the modules that are developed. The module framework communicates with the dial plan via the entry points built in there. This communication allows the module framework to react to specific events in the processing of a call, to determine whether or not a module instance is supposed to handle the call, and, if applicable, to allow this module instance to handle the call. Furthermore, the module framework makes telephony functions available to the modules, and for this purpose it can communicate directly with the switch.

As a part of the module framework, the module run time environment is responsible for carrying out the program code of the modules. It is also responsible for ensuring, in this connection, that the required run time data concerning the call to be processed are available, and for triggering processes in the dial plan on behalf of the modules.

Administration of the modules within the module framework takes place by means of an administrator, by way of separate module manager software. This arrangement allows the administrator to see what modules and module instances are present in the telecommunications system at a certain point in time. Furthermore, he or she can import and export modules with the module manager, and produce, remove, and configure module instances. This function can also take place by way of the user interface, for example, perhaps in adapted form.

All the modules and module instances present in the telephone system are administered in a module library. Furthermore, the module framework can import any desired number of modules from the Internet or other media (CD-ROM, universal serial bus (USB) stick) into the module library, or also export them from there.

Finally, the module timer is a part of the module framework that allows the administrator or module developer to launch specific time-controlled program parts of modules.

It is also advantageously possible to program the telecommunications system remotely. This programming can be done, for example, by configuring the user interface as a web interface that stores the modules directly in the telecommunications system. In this way, programming or also a change can take place from any Internet-capable computer. Furthermore, the distribution of corresponding software can also be eliminated in the case of in-house use.

It is advantageous if the number of terminals administered by the telecommunications system is not limited, but rather is freely scalable, but in any case expandable.

If an error occurs in the system, it seems practical to inform the user about it. For this reason, a success message is played to the user as an audio file during a call, in the case of success, or, in case of a failure, a different audio file is played, which preferably describes the error. Furthermore, it is practical if the telecommunications system sends an error message with a description of the error to an administrator, preferably to an administrator responsible for the defective device. Sending an error message can be done by e-mail, for example.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a block schematic representation of a telecommunications system;

FIG. 2 shows a screen printout of a user interface for creating modules; and

FIG. 3 shows a screen printout of a module manager for administering and instantiating modules.

### DETAILED DESCRIPTION OF PREFERRED EMBODIMENTS

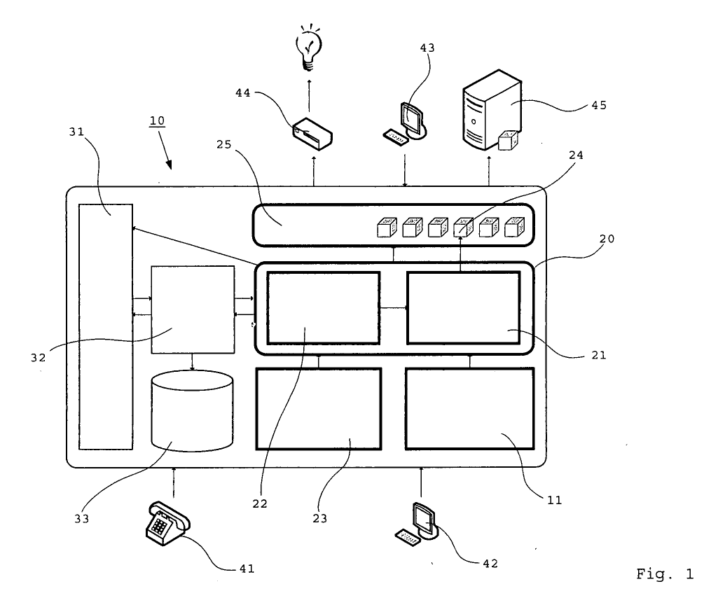

Referring now in detail to the drawings, FIG. 1 shows a telecommunications system 10 in a schematic representation. As an example, a scenario is described in which a lighting system 44 is supposed to be controlled by way of telecommunications system 10. This lighting system 44 supplies lamps with electricity. The goal of the assembly, in the present case, is that a user 41 can turn on the light of lighting system 44 by way of a telephone, by means of a call to a specific telephone number. In this connection, user 41 is supposed to be informed, by way of an announcement, whether or not activation of the light was successful. Furthermore, in case of an error, an e-mail is to be sent to an administrator 42 for lighting system 44.

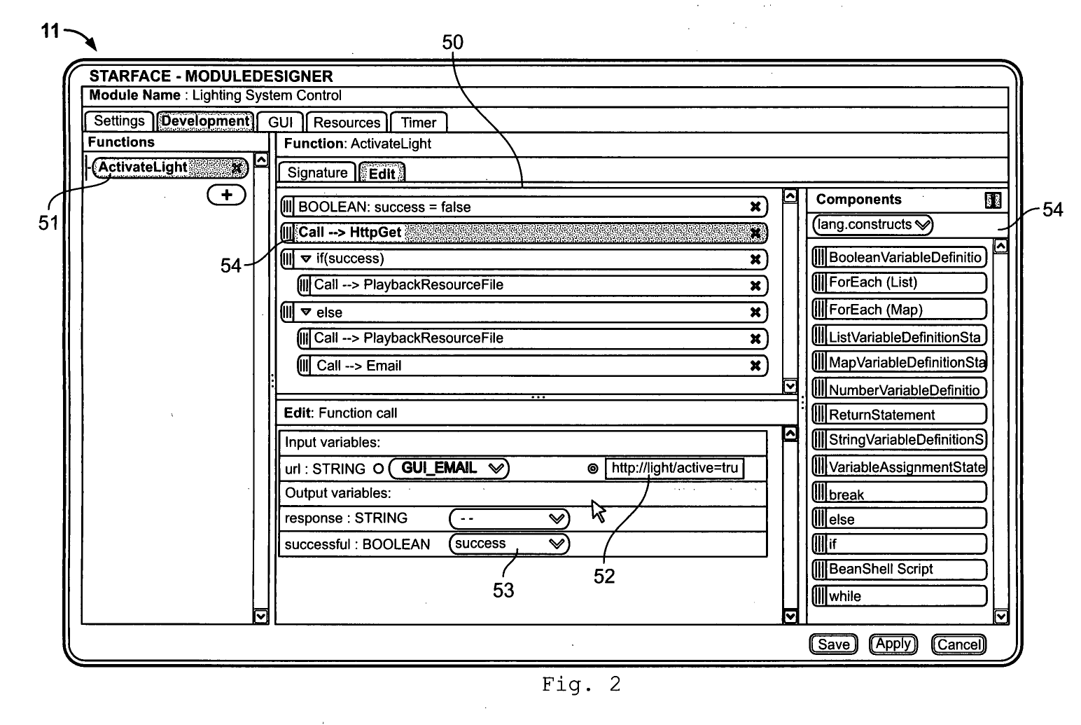

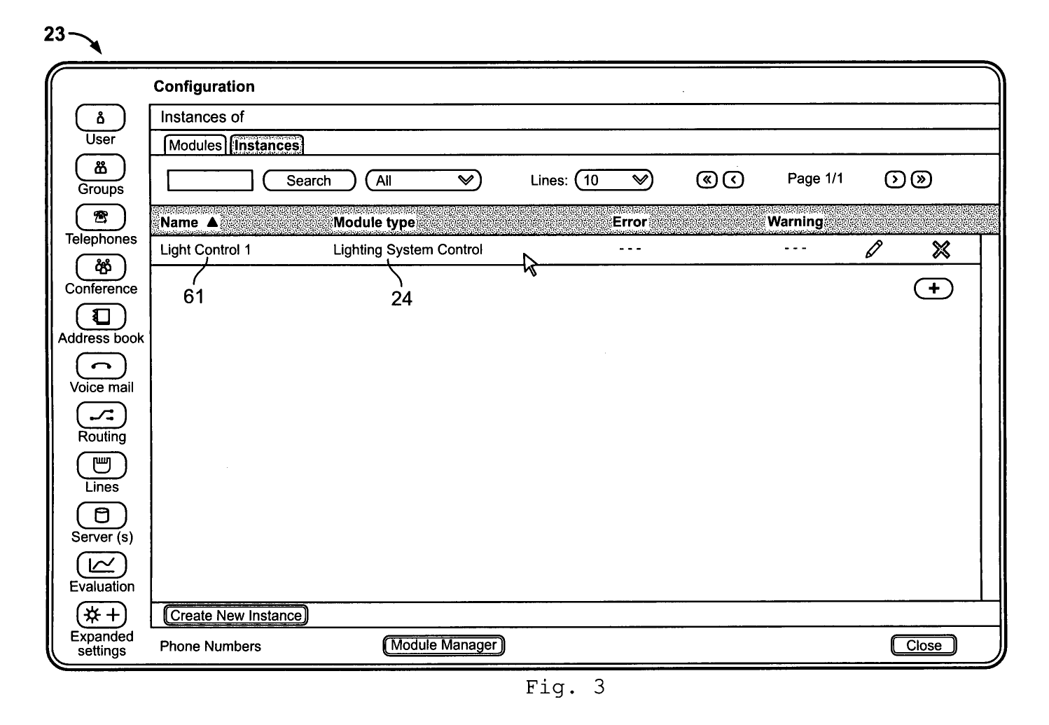

Now, the development and instantiation of a corresponding module 24 will first be described; these are described in FIGS. 2 and 3. Subsequently, we shall return to FIG. 1.

FIG. 2 shows a user interface 11 in the form of a web interface. A module 24 for controlling lighting system 44 can be created by a module developer 43, in simple manner, according to the modular principle by means of user interface 11. For this purpose, a new module is first created in user interface 11.

Subsequently, module developer 43 is asked to add a function 51, which contains the required logic, to new module 24. Such a function 51 does not yet exist at this point in time, so that this function must now be created. For this purpose, a name can be assigned to function 51. In the example, this name is “ActivateLight”.

In a next step, the desired function 51 can be created. For this purpose, a flow diagram 50 is established in the previously created function 51 “ActivateLight”. Flow diagram 50 can be created, in the simplest way, in that functional components or modules 54 that are kept on hand in a catalog are lined up, in their temporal sequence, using drag&drop. The ready-made functional components or modules 54 are made available by other modules or from a module library 25. In the configuration of the “HttpGet” component that is used as an example, setting the parameters takes place in such a way that it calls the lighting system by way of an instruction 52 “http://light/activate=TRUE” and stores the success of this operation as a feedback value 53 “success”.

In the case of success, an announcement is to be issued to user 41. For this purpose, an audio file that was uploaded previously is played to him or her, reporting success of the operation.

In case of an error, an announcement is also played, and in addition, an e-mail is sent to administrator 42 of lighting system 44, by way of an e-mail server 45.

After module 24 has been created in this manner, it is ready to be put into operation. This process is shown in the subsequent FIG. 3.

In order to put module 24 into operation, first an instance 61 has to be produced. An instance 61 is always assigned to an object, here to lighting system 44. As many instances 61 of a module 24 as desired can be created, depending on how many objects having the same functionality are present and are supposed to be controlled in the same manner.

Within the framework of the configuration of instance 61, a telephone number finally has to be assigned to it, as well, with which number the functionality can be triggered. This arrangement has the result, in the example, that now all the calls to this number lead to activation of instance 61 of module 24 and therefore also, in the case of success, to activation of lighting system 44 and finally, of the light.

To illustrate the method of functioning of the module, reference is made to FIG. 1, once again, in the following; the sequence of a control process will be explained with a small scenario.

In a first step, a user 41 calls telecommunications system 10 with the telephone number of lighting system 44. A switch 31 processes the call signal and delegates a dial plan 32 to pass the call on. Dial plan 32 determines, on the basis of rules stored in a routing database 33, that the call is assigned to an instance 61, instructs switch 31 to take the call, and delegates the call handling to the module framework 20. A module run time environment 21 now carries out the function “ActivateLight” of module 24 from module library 25. The function 51 “ActivateLight” calls up functional component 54 “HttpGet” from a system-internal module. This functional component passes the call through to lighting system 44, which in turn turns on the light.

The function “ActivateLight” calls up the function “PlaybackResourceFile” from a system-internal module. This function causes switch 31 to reproduce the announcement file stored in the module in the telephone call, in other words to play a success message. In the case of failure, a corresponding failure message would be played, and an e-mail would be sent to administrator 42 who is responsible for the lighting system 44, by way of an e-mail server 45. If changes in module 24 were necessary, administrator 42 could take care of them by way of a module manager 23 or a user interface 11.

Module timer 22 shown in FIG. 1 is a part of the module framework that allows administrator 42 or module developer 43 to launch specific time-controlled program parts of modules 24.

A telecommunications system is therefore described above, which makes it possible to undertake simple and individual programming of terminals, and to control them by way of a telephone system. No programming experience on the part of the user is necessary in this connection.

Accordingly, although only a few embodiments have been shown and described, it will be apparent that many changes and modifications may be made thereunto without departing from the spirit and scope of the invention.

What is claimed is:

1. A telecommunications system comprising
(a) a plurality of open interfaces for producing a data connection with terminals;
(b) an administration device for administering the terminals;
wherein said administration device comprises a user interface for programming the administration device to create functions or modules for controlling the terminals, said functions or modules comprising a plurality of ready-made functional components.

2. The telecommunications system according to claim 1, wherein the user interface supplementally also allows free programming of the functions or modules for controlling the terminals.

3. The telecommunications system according to claim 1, wherein the terminals can be controlled by way of the administration device by a user using a telephone connected with the administration device.

4. The telecommunications system according to claim 1, comprising a virtual telephone system implemented via software on a data processing device.

5. The telecommunications system according to claim 1, wherein at least one function is created by the administrative device via the user interface as a flow diagram.

6. The telecommunications system according to claim 5, wherein the function is created first in XML in a platform-independent manner and subsequently converted to Java or binary code for implementation.

7. The telecommunications system according to claim 1, wherein the administration device creates functions combined in modules and wherein the modules represent self-contained program units.

8. The telecommunications system according to claim 7, wherein the administration device has a module framework functioning as a central administration unit for the modules.

9. The telecommunications system according to claim 8, wherein the modules have program code and the module framework has a module run time environment that carries out the program code of the modules, as needed.

10. The telecommunications system according to claim 8, further comprising module manager software for administering the modules within the module framework.

11. The telecommunications system according to claim 7, wherein ready-made modules or functions are created on a user side and stored in a module library for reuse.

12. The telecommunications system according to claim 11, wherein the ready-made functions or modules can be called up by way of an Internet portal and added to the module library.

13. The telecommunications system according to claim 7, wherein the modules have a standard structure.

14. The telecommunications system according to claim 1, wherein the user interface is directly assigned to the administration device or is a web interface.

15. The telecommunications system according to claim 14, wherein the user interface comprises a graphic interface.

16. The telecommunications system according to claim 1, wherein the administration device administers a number of the terminals, the number being freely scalable by adding and removing terminals, at least to a great extent.

17. The telecommunications system according to claim 1, wherein the administration device creates modules and the user interface allows administration of the modules.

18. The telecommunications system according to claim 1, wherein each terminal comprises an electrical device that can be used with at least one switching signal.

19. The telecommunications system according to claim 18, wherein when an error occurs in the terminal, an e-mail error message is sent by an e-mail server to an administrator assigned to the terminal.
